(19) United States
(12) Patent Application Publication
(10) Pub. No.: US 2018/0342911 A1
(43) Pub. Date: Nov. 29, 2018

(54) WIRELESS CHARGING LIGHTING DEVICE

(71) Applicant: Xiamen Dong'ang Illumination Technology Co., Ltd., Xiamen (CN)

(72) Inventors: Junhui Zhuang, Xiamen (CN); Xun Chen, Xiamen (CN); Yubing Zhu, Xiamen (CN)

(21) Appl. No.: 15/989,189

(22) Filed: May 25, 2018

(30) Foreign Application Priority Data
May 27, 2017 (CN) 201720608362.8

(51) Int. Cl. H02J 50/90; H02J 7/02; H02J 50/10; H01F 38/14; H02J 7/00

(52) U.S. Cl. CPC H02J 50/90; H02J 7/025; H02J 7/0047; H01F 38/14; H02J 50/10

(57) ABSTRACT

A wireless charging lighting device includes a charging transmitter and a charging receiver. The charging transmitter includes transmitter coil for transmitting power and a transmitter base for supporting the transmitter coil. The transmitter base includes two first positioning magnets. The two first positioning magnets are respectively placed on two sides of the transmitter coil. The charging receiver includes a receiver coil for receiving power, a fighting device electrically connected to the receiver coil, and a housing for packaging the receiver coil and the lighting device. Two sides of the receiver coil have a second positioning magnet, respectively. The magnetic attraction between the first positioning magnets and the second positioning magnets aligns the transmitter coil to the receiver coil.

### CROSS REFERENCE OF RELATED APPLICATION

The present application claims the benefit of Chinese Patent Application No. 201720608362.8, filed on May 27, 2017, in the State Intellectual Property Office of China, the content of which is hereby incorporated by reference.

### TECHNICAL

This disclosure relates to the field of lighting technology, especially to a wireless charging lighting device.

### BACKGROUND ART

Common working lights presently on the market, such as a mining light, headlamp, or the like, currently adopt a contact charging method, which requires a charging interface and charging wires to charge a working light, which would affect the Ingress Protection (“IP”) Rating of the product. Furthermore, the working lights, especially the mining lights, are usually used in environments such that the interface is likely to be exposed to dirt or other contaminants that would likely create problems including poor contact at the interface.

### SUMMARY

This disclosure relates to a wireless charging lighting device.

An embodiment of the present disclosure includes a wireless charging lighting device comprising a charging transmitter and a charging receiver. The charging transmitter includes a transmitter coil for transmitting power and a transmitter base for supporting the transmitter coil. The transmitter base includes two first positioning magnets respectively placed on two sides of the transmitter coil. The charging receiver includes a receiver coil for receiving power, a lighting device electrically connected to the receiver coil, and a housing for packaging the receiver coil and the lighting device. Two sides of the receiver coil have a second positioning magnet, respectively. The first positioning magnet and the second positioning magnet are attracted to each other to bring the charging transmitter and/or the charging receiver towards each other, and accordingly the transmitter coil and the receiver coil to each other.

In some embodiments of the present disclosure, a distance between the first positioning magnet and the second positioning magnet is greater than or equal to 8 mm.

In some embodiments of the present disclosure, when the charging transmitter contacts the charging receiver, a distance between the transmitter coil and the receiver coil is in range of about 3 to 8 mm.

In some embodiments of the present disclosure, the transmitter base comprises a switch controller for controlling power from the power supply to the transmitter coil, when the charging transmitter contacts the charging receiver, the transmitter coil is supplied with power.

In some embodiments of the present disclosure, the charging receiver comprises a long side and a short side, the receiver coil is extended along the short side to an edge of the charging receiver, and the two second positioning magnets are arranged on two sides of the receiver coil along the direction of the long side.

In some embodiments, the receiver coil comprises a first surface and a second surface opposite the first surface, the first surface faces the charging transmitter, and the second surface is away from the charging transmitter, and a magnet plate is arranged adjacent to the second surface and completely covers the second surface.

In some embodiments, the transmitter base comprises a fixture member for anchoring the transmitter base.

In some embodiments, one surface, away from the charging receiver, of the transmitter base comprises a fixed magnet.

In some embodiments, a display layer is arranged on an outer surface where the charging transmitter contacts the charging receiver.

In some embodiments, the transmitter base comprises an internal power source electrically connected to the transmitter coil.

### BRIEF DESCRIPTION OF THE DRAWINGS

The embodiments of the disclosure will become apparent and more readily appreciated from the following description of the embodiments, taken in conjunction with the accompanying drawing.

FIG. 1 is a schematic diagram of the wireless charging lighting device according to one embodiment of the disclosure.

FIG. 2 is a schematic diagram of a lighting device of the wireless charging lighting device. according to one embodiment of the disclosure.

FIG. 3 is a schematic diagram of a charging transmitter according to one embodiment of the disclosure.

FIG. 4 is a schematic diagram of a charging receiver according to one embodiment of the disclosure.

FIG. 5 is schematic diagrams of magnetic induction lines between the transmitter coil and the receiver coil, wherein A shows the magnetic induction lines of the transmitter coil and the receiver coil without a magnetic plate, and B shows the magnetic induction lines of the transmitter coil and the receiver coil with the magnetic plate.

### DETAILED DESCRIPTION

Hereinafter, tins disclosure will be described in detail in combination with the embodiments and drawings for better understanding the objective, technical solutions and advantages of the present disclosure.

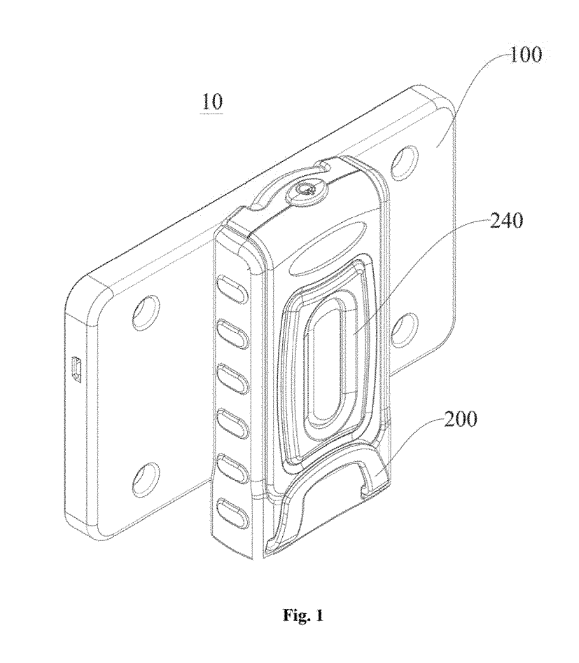

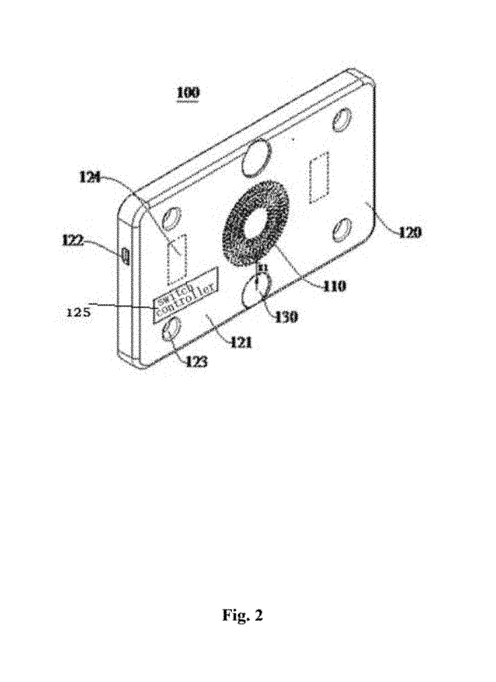

Referring to FIGS. 1-3, a wireless charging lighting device 10 comprises a charging transmitter 100 for providing power and a charging receiver 200 for receiving power.

The charging transmitter 100 includes a transmitter coil 110 for transmitting power, and a transmitter base 120 for supporting the transmitter coil 110. The transmitter base 120 comprises two first positioning magnets 130 arranged thereon. The two first positioning magnets 130 may be separately arranged on two sides (e.g., opposite sides) of the transmitter coil 110.

The charging receiver 200 is the electric equipment to be charged. The charging receiver 200 includes a receiver coil 210, a lighting device 240 electrically connected to the receiver coil 210, and a housing 220 for packaging the, receiver coil 210 and the lighting device 240. Two sides (e.g., opposite sides) of the receiver coil 210 are provided with a second positioning magnet 230, respectively.

During charging, the charging transmitter 100 may be electrically connected to an external power source or an internal power source to energize the transmitter coil 110. When a current flows through the transmitter coil 110, a magnetic field is generated. Once the uncharged receiver coil 210 approaches said magnetic field, a current will be generated to power the lighting device 240.

In one embodiment, the transmitter base 120 comprises a case 121, wherein the transmitter coil 110 is disposed within the case 121. The transmitter base 120 further comprises a current input interlace 122, configured for receiving an external power source to load current onto the transmitter coil 110. In this embodiment, the input interface 122 may be a Micro input interface located on a side wall of the transmitter base 120.

In an alternative embodiment, internal power source, such as battery, may be arranged within the transmitter base 120 to supply current to the transmitter coil 110, so as to further improve the flexibility and convenience of the charging operation.

When the charging receiver 200 is placed on the charging transmitter 100, the charging operation can be realized. Both the lighting device 240 and the receiver coil 210 can be packaged within the housing 220 of the charging receiver 200. The housing 220 can be waterproof and dirt proof to increase the IP Rating of the wireless charging lighting device 10. That is, the housing 220 protects the lighting device 240 and the transmitter coil 210 from its surroundings, which prolongs the work life of the charging receiver 200 and the wireless charging lighting device 10.

In one embodiment, the lighting device 240 is electrically connected to the receiver coil 210. More specifically, the receiver coil 210 can be electrically connected to an illuminating unit of the lighting device 240, for example, a LED. Alternatively, the receiver coil 210 may be connected to a charging battery within the lighting device 240 and the charge can be stored in the charging battery.

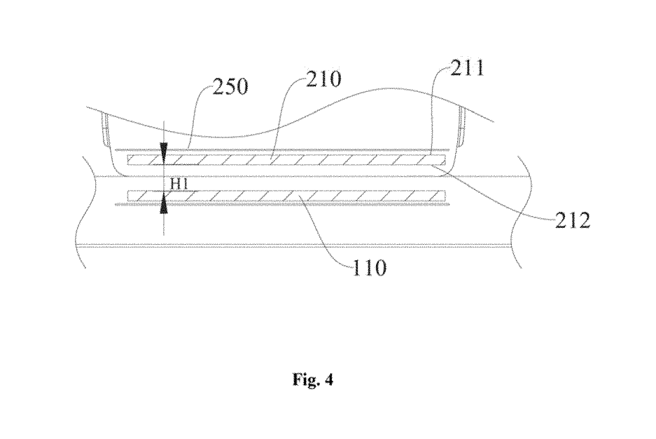

In one embodiment, the first positioning magnets 130 are arranged at two sides of the transmitter coil 110, respectively, and the second positioning magnets 230 are arranged at two sides of the receiver coil 210. As the charging receiver 200 is placed on the charging transmitter 100 for charging, the magnetic forces of attraction between the first positioning magnets 130 and the second positioning magnets 230 can automatically position the charging receiver 200 relative to the charging transmitter to properly align the transmitter coil 110 to the receiver coil 210. Referring, to FIG. 4 when the two coils are properly positioned adjacent to one another, the projections of the two coils on a horizontal plane are substantially overlapping. That is, when the magnetic lines of the transmitter coil 110 and the receiver coil 210 are properly aligned, the coupling area is maximized, which can effectively ensure maximum charging. The first positioning magnet 130 and the second positioning magnet 230 can also ensure that the charging transmitter 100 and the charging receiver 200 are attached together, depending on the strength of the magnetic attraction forces between the two, and avoid relative movement therebetween caused by shocks, vibration, accidental touching, or other external forces.

In one embodiment, both the first positioning magnet 130 and the second positioning magnet 230 are neodymium-iron-boron magnets.

In alternative embodiments of the disclosure, the first positioning magnet 130 may be an electromagnet while the second positioning magnet 230 may be or include a magnetically attractable material, such as iron, cobalt, or nickel. When a current is applied to the transmitter coil 110, the current can, at the same time, be applied to the first positioning magnet 130 to attract the second positioning magnet 230.

In addition, precise positioning of the transmitter coil 110 and the receiver coil 210 can be achieved by two-point positioning through magnetic attraction between the two first positioning magnets 130 and the two second positioning magnets 230. Although, in some embodiments, the magnetic field of the magnet itself may affect the electromagnetic it charging process, the two-point positioning may reduce the use of additional magnets and thereby increase the charging efficiency.

In order to avoid the magnetic property of the first positioning magnet 130 affecting the process of the electromagnetic induction charging, a distance S1 between the first positioning magnet 130 and the transmitter coil 130 may at least be 8 mm. Similarly, a distance S2 between the second positioning magnet 130 and the transmitter coil 130 in the horizontal direction may at least be arranged to be 8 mm. More preferably, S1 and S2 can be in a range of 8 mm to 20 mm, for example, 9 mm, 10 mm, and 15 mm.

Referring to FIG. 4, when the charging receiver 200 is placed on the charging transmitter 100, a distance H1 bet peen the transmitter coil 110 and the receiver coil 210 may be in the range of 3 mm to 8 mm. The distance H1 is determined such that the transmitter coil 110 emits the maximum magnetic field energy to the receiver coil 210 and the magnetic flux is maximized, thereby improving the energy conversion effect and reducing the energy waste from low efficient charging. More specifically, the receiver coil 210 and the second positioning magnets 230 can be arranged on the inner surface of the housing 220 of the charging receiver 200. Similarly, the transmitter coil 110 and the first positioning magnet 130 may be arranged on the inner surface of the case 121 of the transmitter base 120.

In one embodiment, the transmitter coil 110 and the receiver coil 210 are both circular coils made of wound wires of magnetic alloy. The transmitter coil 110 and the receiver coil 210 are quite similar in shape and size so as to maximize the energy conversion efficiency. Preferably, the transmitter coil 110 and the receiver coil 210 are circular.

In alternative embodiments, the transmitter coil 110 and the receiver coil 210 may be, but not limited to, rectangular or any other shape.

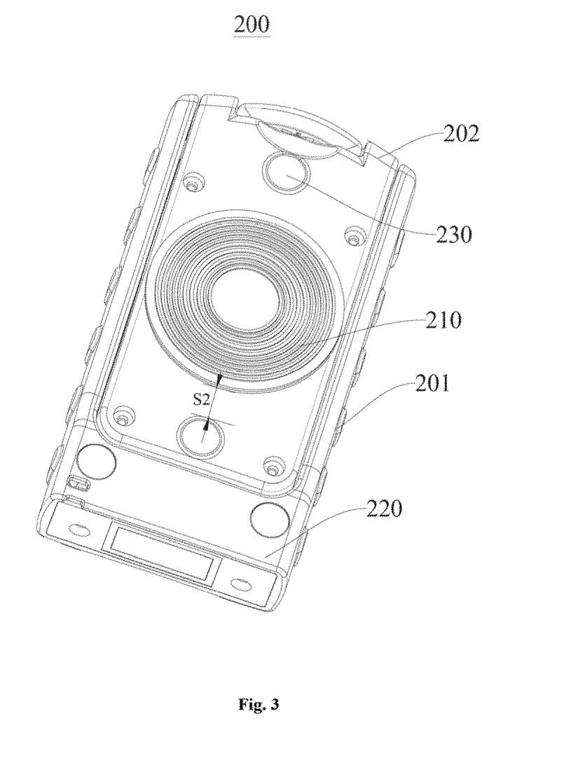

In one embodiment, as shown in FIG. 3, the charging receiver 200 can comprise a long side 201 and a short side 202, wherein the receiver, coil 210 spans across the short side 202 to edges of the charging receiver 200. The two second positioning magnets 230 are arranged on two sides of the receiver coil 210 along the direction of the long side 201, which means that the radial length of the receiver coil 210 is substantially equal to the length of the short side 202. Moreover, the greater the number of coils of the receiver coil 210, the larger the magnetic flux and a more effective charging.

The receiver coil 210 comprises a first surface 211 and a second surface 212 opposite to the first surface 211, wherein the first surface 211 is a surface facing the charging transmitter 100, and the second surface 212 is a surface away from the charging transmitter 100. A magnetic plate 250 can be located adjacent to the first surface 211. The magnetic plate 250 can completely cover one side of the receiver coil 210.

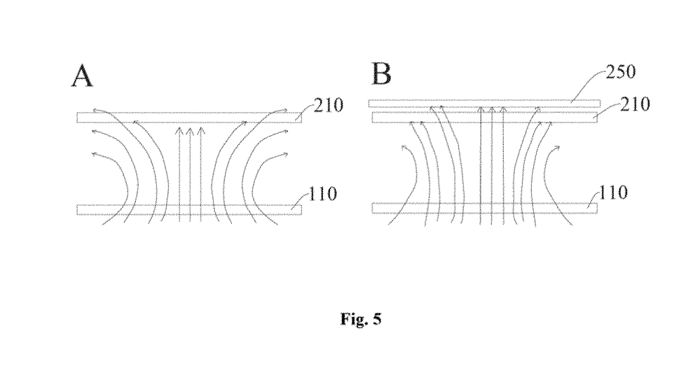

When a current flows through the transmitter coil 110, a magnetic field is generated. The magnetic property of the transmitter coil 110 can be properly utilized in order to maximize the magnetic energy transmitted by the transmitter coil 110 to the receiver coil 210. Referring to FIG. 5, in which A shows the magnetic induction line of the transmitter coil 110 and the receiver coil 210 without a magnetic plate 250, and B shows the magnetic induction line of the transmitter coil and the receiver coil with magnetic plates 250. After a magnetic plate 250 is installed, the magnetic lines gather and concentrate obviously. The magnetic plate 250 provides a magnetic line loop for the magnetic field and gathers the magnetic field so that the magnetic field can be applied to the receiver coil at its maximum. By doing so, the best power performance can be reached.

The magnetic plate 250 not only can effectively be magnetic conductive, but also can be served as magnetic shield. When the changing magnetic field comes across a metal conductor, a current may be generated if the metal is closed. If the metal is open, especially a whole piece metal, the eddy current effect could be incurred. The eddy current effect can generate mounts of heat. The electromagnetic signal could be easily decreased by the influence of the metal conductor, which leads to energy waste. Providing a magnetic plate 250 on the second surface 212 of the receiver coil 210 could protect the magnetic field from being influenced, by the metal conductor, thus improving the charging efficiency. Similarly, the magnetic plate 250 may be arranged on one side of the receiver coil 210 away from the charging receiver 200 to further improve the charging efficiency.

In order to prevent the charging transmitter 100 from generating a magnetic field when not charged, the transmitter base 120 can comprise a switch controller 125 for controlling the on/off of the transmitter coil 110. When the charging receiver 200 is placed on the charging transmitter 100, the switch controller 125 turns on the power supply to the transmitter coil 110. When the charging receiver 200 is removed away from the charging transmitter 100, the switch controller 125 switches off the power supply to the transmitter coil 110.

In other embodiments of this disclosure, the transmitter 120 may comprise a detection sensor for detecting whether the charging receiver 200 is placed on the charging transmitter loo, and for generating a detection signal. The switch controller 125 may switch on or switch off the power supply to the transmitter coil 110 according to the detection signal. In some other embodiments, the transmitter base 120 may comprise a press button on the surface contacting the charging receiver 200 for controlling, the power from the power supply to the transmitter coil 110, When the charging receiver 200 is placed on the transmitter base 120, the press button can be pressed to switch on the power supply to the transmitter coil 110. When the charging receiver 200 is removed away from the transmitter base 120, the press button can be reset to switch off the power supply to the transmitter coil 110.

In one embodiment, in order to facilitate the charging operation, a fixture member 123 can be arranged on the transmitter base 120 so that the charging transmitter 100 can be attached to a desk, a wall, or other mounting surface. In the embodiment, the fixture member 123 can be screw holes arranged on the four corners of the transmitter base 120. Screw fasteners may be used to anchor the transmitter base 120.

Additionally, a fixed magnet 124 may be arranged on a surface of the transmitter base 120 away from the charging receiver 200, so that the charging transmitter 100 can be attached to a metal object.

In other embodiments of this disclosure, buckles or clamping members may be used to attach the charging transmitter 100.

The charging surface where the charging transmitter 100 contacts the charging receiver 200 can comprise a silicon rubber located on the charging transmitter 100 and/or the charging receiver 200. When the charging transmitter 100 is not placed flat during charging, such as at an angle, the silicon rubber may increase the friction between the charging receiver 200 and the charging transmitter 100, to prevent the charging receiver 200 from sliding off and detaching from the transmitting receiver under the force of gravity, shock, or external forces.

In one embodiment, the transmitter coil 110 and the receiver coil 210 are both assembled inside the device, so that the transmitter coil 110 and the receiver coil 210 cannot be rapidly aligned with each other. In order to address this problem, the outer surface where the charging transmitter 100 contacts the charging receiver 200 is further provided with a display layer (not shown) for displaying the position of the coils. The display layer shows the operator the position of the transmitter coil 110 and the receiver coil 210 so that the transmitter coil 110 and the receiver coil 210 can be properly aligned. Additionally, with the help of the first, positioning magnets 130 and the second positioning magnets 230, only slight correction would be needed to precisely align the transmitter coil 110 and the receiver coil 210.

In the embodiments of this disclosure, the display layer may be a graphic. That is, a substantial position of the transmitter coil 110 and the receiver coil 210 may be drawn on the contact surface. In other embodiments, the display layer may be, but not limited to, a convex surface formed on the contact surface to indicate the position of the transmitter coil 110 and the receiver coil 210.

The wireless charging lighting device 10 provided in the present disclosure uses the transmitter coil 110 on the charging transmitter 00 and the receiver coil 210 on the charging receiver to generate an electromagnetic induction process, which allows a contactless charging. The lighting device 240 and the receiver coil 210 both are disposed within the housing 220 which comprises no charging interface. That means the product can be a sealed design with a high IP Rating, and be waterproof and dustproof. No conductor is exposed during the charging process of the wireless charging lighting device 10, thereby increasing the reliability and safety of the device.

The first positioning magnet 130 and the second positioning magnet 140 can accurately and consistently align the transmitter coil 110 to the receiver coil 210, to ensure efficient charging. The arrangement of the relative location of the magnets and the coils, and the relative location of the transmitter 110 and the receiver coil 210 may further reduce energy loss.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the exemplary embodiments described above may be modified within the scope of the claims.

1. A wireless charging lighting device, comprising a charging transmitter and a charging receiver;
wherein the charging transmitter comprises a transmitter coil for transmitting power and a transmitter base for supporting the transmitter coil; the transmitter base includes a first positioning magnets placed on the transmitter coil;
the charging receiver comprises a receiver coil for receiving power, a lighting device electrically connected to the receiver coil, and a housing for packaging the receiver coil and the lighting device; the receiver coil have a second positioning magnet;
the first positioning magnet and the second positioning magnet are magnetically attracted to each other to align the transmitter coil to the receiver coil and at least partially hold the charging receiver and the charging transmitter together.

2. The wireless charging lighting device according to claim 1, wherein two first positioning magnets respectively placed on two sides of the transmitter coil; two sides of the receiver coil have a second positioning magnet, respectively.

3. The wireless charging lighting device according to claim 1, wherein a distance between the first positioning magnet and the second positioning magnet is greater than or equal to 8 mm.

4. The wireless charging lighting device according to claim 1, wherein when the charging transmitter contacts the charging receiver, and a distance between the transmitter coil and the receiver coil is in a range of 3 mm to 8 mm.

5. The wireless charging lighting device according to claim 2, wherein the transmitter base comprises a switch controller for controlling power from a power supply to the transmitter coil; when the charging transmitter contacts the charging receiver, the switch controller directs power to the transmitter coil.

6. The wireless charging lighting device according to claim 1, wherein the charging receiver comprises a long side and a short side, wherein the receiver coil spans across the short side to opposite edges of the short side; the two second positioning magnets are arranged on opposite sides of the receiver coil along a direction of the long side.

7. The wireless charging lighting device according to claim 1, wherein the receiver coil comprises a first surface and a second surface opposite the first surface, the first surface faces the charging transmitter, the second surface faces away from the charging transmitter, and a magnetic plate is arranged adjacent to the second surface and completely covers the second surface.

8. The wireless charging lighting device according to claim 1, wherein the transmitter base comprises a fixture member for anchoring the transmitter base to a mounting surface.

9. The wireless charging lighting device according to claim 1, wherein a surface of the transmitter base away from the charging receiver comprises a fixed magnet for mounting the transmitter base to a metal object.

10. The wireless charging lighting device according to claim 1, wherein a display layer indicating the position of at least one of the receiver coil and the transmitter coil is arranged on a surface of at least one of the charging receiver and the charging transmitter.

11. The wireless charging lighting device according to claim 1, wherein the transmitter base comprises an internal power source electrically connected to the transmitter coil.
